(19) United States
(12) Patent Application Publication
(10) Pub. No.: US 2016/0098639 A1
(43) Pub. Date: Apr. 7, 2016

(54) METHOD AND APPARATUS FOR ESTIMATING POWER CONSUMPTION BASED ON TEMPERATURE

(71) Applicant: Encored Technologies, Inc., Seoul (KR)

(72) Inventors: Jong-Woong CHOE, Seoul (KR); Hyoseop LEE, Seoul (KR); Seonjeong LEE, Seoul (KR); Dae Young KIM, Seoul (KR); Hyunjin AHN, Seoul (KR); Kyunghun PARK, Seoul (KR)

(73) Assignee: ENCORED TECHNOLOGIES, INC., Seoul (KR)

(21) Appl. No.: 14/861,050

(22) Filed: Sep. 22, 2015

(30) Foreign Application Priority Data
Oct. 7, 2014 (KR) 10-2014-0134958

(51) Int. Cl. G06N 5/04; G06N 99/00

(52) U.S. Cl. CPC G06N 5/04; G06N 99/005

(57) ABSTRACT

Accordingly the embodiments herein achieve a method and apparatus for estimating power consumption based on a temperature. The method includes dividing a use time and a non-use time based on an analysis of a correlation of a determined temperature and a power consumption based on the determined temperature. Further, the method includes extracting a base consumption of an electrical apparatus based on power consumption during the non-use time. Further, the method includes extracting a threshold temperature and a power consumption continuous function based on the threshold temperature and power consumption. The threshold temperature requires a maximum operation of the electrical apparatus. Furthermore, the method includes calculating the power consumption based on a predetermined temperature from the power consumption continuous function; and calculating an estimated power consumption except for the base consumption.

### TECHNICAL FIELD

The present invention relates to power management system, and more particularly, a method and an apparatus for estimating power consumption based on a temperature.

### BACKGROUND

As power facilities, air-conditioning facilities, control facilities, and the like in a building are complicated, management of such facilities has been systematized. In recent years, computer mechanisms has been applied as an automatic control means for operating, controlling, and managing the facilities. With the application of the computer mechanisms as the automatic control means, various convention system and method attempts to control and manage the facilities for energy management.

The conventional facility management systems or building automated systems focuses on automation for an appropriate operation by monitoring whether the facilities in the building normally operate. Generally, as the energy consumed in each facility is degraded to be subsidiary, the control and management of the facilities involves significant challenges.

Further, the existing cooling and heating energy saving system proposes a method that analyzes power consumption for each time by a behavior pattern of a resident or an apparatus using pattern to save cooling and heating energy. However, such method or apparatus saves energy through a past pattern and arithmetically estimates detailed energy consumption and compares the estimated energy consumption with actual consumption. As a result, an abnormal is determined in the facility itself or information for saving direct energy use cannot be provided through estimated predicted energy consumption.

### SUMMARY OF INVENTION

In order to solve the technical problems, an object the embodiments herein is to propose a method that can estimate power consumption by acquiring a relationship of the power consumption based on a temperature. Another object of the embodiments is to provide use notification information regarding an abnormal situation by proposing a consumption estimating method based on whether a user is present in a building.

Accordingly the embodiments herein provide a method for estimating power consumption based on a temperature. The method includes dividing a use time and a non-use time based on an analysis of a correlation of a determined temperature and a power consumption based on the determined temperature. Further, the method includes extracting a base consumption of an electrical apparatus based on power consumption during the non-use time. Further, the method includes extracting a threshold temperature and a power consumption continuous function based on the threshold temperature and power consumption. The threshold temperature requires a maximum operation of the electrical apparatus. Furthermore, the method includes calculating the power consumption based on a predetermined temperature from the power consumption continuous function; and calculating an estimated power consumption except for the base consumption.

In an embodiment, the method further includes excluding abnormal power consumption beyond a predetermined range with respect to an average of the collected power consumption. The correlation is analyzed between the power consumption except for the abnormal power consumption and the determined temperature.

In an embodiment, the base consumption is a center value of the power consumption during the non-use time.

In an embodiment, extracting the threshold temperature and the power consumption continuous function based on the threshold temperature and power consumption includes extracting the power consumption continuous function for the power consumption at a first threshold temperature, the first threshold temperature requires a maximum operation of a heating apparatus; extracting the power consumption continuous function for the power consumption at a second threshold temperature, the second threshold temperature requires a maximum operation of a cooling apparatus; and extracting the power consumption between the first threshold temperature and the second threshold temperature.

In an embodiment, the estimated power consumption is calculated by excluding the base consumption and a minimum value of the power consumption continuous function from the calculated power consumption.

In an embodiment, further including calculating power consumption of a non-Heating Ventilating and Air Conditioning (HVAC) apparatus except for the base consumption and the estimated power consumption in the calculated power consumption.

Accordingly the embodiments herein provide an apparatus for estimating power consumption based on a temperature. The apparatus includes a data collecting unit configured to collect environmental information including power consumption and temperature information. Further, the apparatus includes a relationship extracting unit configured to analyze a correlation of a determined temperature and the power consumption based on the sensory temperature; and divide a use time and a non-use time based on the analysis of the correlation. Further, the relationship extracting unit is configured to extract a base consumption of an electrical apparatus based on power consumption during the non-use time; and extract a threshold temperature and a power consumption continuous function based on the threshold temperature and power consumption. The threshold temperature requires a maximum operation of the electrical apparatus. Further, the apparatus includes an estimated power consumption calculating unit configured to calculate the power consumption based on a predetermined temperature from the power consumption continuous function; and calculate the estimated power consumption except for the base consumption.

Accordingly the embodiments herein provide a method for estimating power consumption based on a temperature. The method includes dividing a use time and a non-use time based on an analysis of a correlation of a determined temperature and a power consumption based on the determined temperature. Further, the method includes extracting a base consumption of an electrical apparatus based on power consumption during the non-use time; and extracting a threshold temperature and a power consumption continuous function based on the threshold temperature and power consumption. The threshold temperature requires a maximum operation of the electrical apparatus.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE FIGURES

This invention is illustrated in the accompanying drawings, throughout which like reference letters indicate corresponding parts in the various figures. The embodiments herein will be better understood from the following description with reference to the drawings, in which:

FIG. 1 is a flowchart illustrating a method for estimating power consumption based on a temperature, according to the embodiments as described herein;

FIG. 2 is an example graph illustrating removal of an abnormal value, according to the embodiments as described herein;

FIG. 3 is an example graph illustrating a correlation of the power consumption based on a sensory temperature, according to the embodiments as described herein;

FIG. 4 is an example diagram illustrating a temperature or power consumption continuous function, according to the embodiments as described herein;

FIG. 5 is an example graph illustrating estimation of power consumption of an HVAC, according to the embodiments as described herein;

FIG. 6 is an example illustrating a power consumption prediction result, according to the embodiments as described herein; and

FIG. 7 is an example graph illustrating an apparatus for estimating power consumption based on a temperature, according to the embodiments as described herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Accordingly the embodiments herein achieve a method and apparatus for estimating power consumption based on a temperature. The method includes dividing a use time and a non-use time based on an analysis of a correlation of a determined temperature and a power consumption based on the determined temperature. Further, the method includes extracting a base consumption of an electrical apparatus based on power consumption during the non-use time. Further, the method includes extracting a threshold temperature and a power consumption continuous function based on the threshold temperature and power consumption. The threshold temperature requires a maximum operation of the electrical apparatus. Furthermore, the method includes calculating the power consumption based on a predetermined temperature from the power consumption continuous function; and calculating an estimated power consumption except for the base consumption.

In an embodiment, a relationship of power consumption based on a purpose, for example, a power consumption pattern is separated by considering whether a user is present in a building to provide consumption for respective patterns. Further, estimated power consumption and actual power consumption are compared to provide user notification information regarding an abnormal situation. Furthermore, future power consumption prediction information can be provided through a relationship of calculated temperature or power consumption.

Based on the big data of correlation between energy consumption and temperature, the proposed system and method distinguishes the non-use time from the use time data for HVAC. Unlike the conventional system and method, the accuracy of power consumption prediction based on a temperature is significantly increased by preventing the non-use time data from smoothing out the use time data. Further, the proposed system and method can be implemented using existing infrastructure and may not require extensive setup and instrumentation.

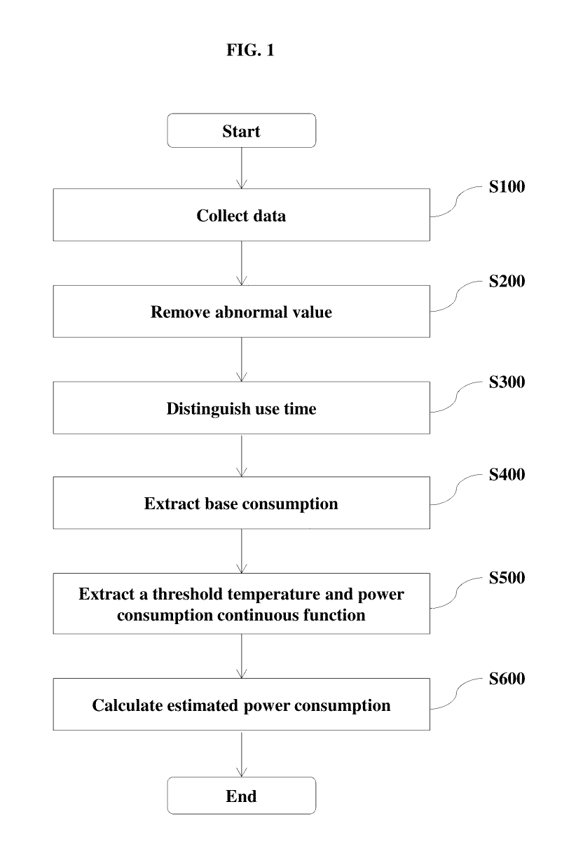

Referring now to the drawings and more particularly to FIGS. 1 to 7 where similar reference characters denote corresponding features consistently throughout the figures, there are shown preferred embodiments.

FIG. 1 is a flowchart illustrating a method for estimating power consumption based on a temperature, according to the embodiments as described herein. In embodiment, the method for estimating power consumption includes a data collecting step (S100), an abnormal value removing step (S200), a use time dividing step (S300), a base consumption extracting step (S400), a threshold temperature and power consumption continuous function extracting step (S500), and an estimated power consumption calculating step (S600).

In an embodiment, in the data collecting step (S100), environmental information including the power consumption and temperature information is collected. The environmental information may include humidity information in addition to the temperature information. The information is collected together with temporal information.

Further, in an embodiment, the environmental information may include information which the power consumption of a user may influence in addition to the temperature or humidity information. For example, the environmental information includes a wind velocity, a sensory temperature, a microdust level, a CO₂ level, microdust, yellow dust, an ozone amount, an infectious disease, or the like. Other examples of the environmental information may include date information, holiday information, or the like.

Further, in the abnormal value removing step (S200), abnormal power consumption other than a predetermined range with respect to an average of the collected power consumption is excluded. That is, by removing the abnormal value to calculate more accurate information, the power consumption collected for each time may be collected as daily data. Thereafter, the abnormal values for the respective data may be removed.

In an embodiment, by applying a Chauvenet's criterion, when given data deviates from an average at some degree, the value is excluded. In detail, an average μ and a standard deviation σ are calculated from given data x1, x2, . . . , xn. xi satisfies a decided relational formula, n·erfc(|xi−μ|/σ)<0.5 is regarded as the abnormal value and excluded from a measurement value. Herein, erfc represents a complementary abnormal function.

Through such a process, when an expectation value for the number of measurement times of the data which deviates from the average is smaller than 0.5, the data will be excluded. In this case, the figure, 0.5 is a variable which is customarily used in statistics and may be changed by the user according to the quality of the data.

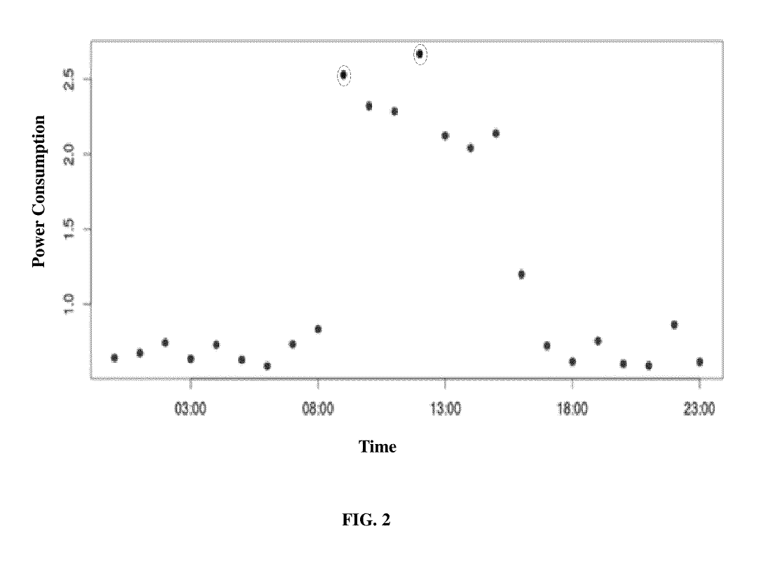

FIG. 2 is an example illustrating a process of removing an abnormal value through the aforementioned method, according to embodiments as described herein. When the power consumption is expressed by points for each time, points expressed with dotted circles are determined as the abnormal value to be excluded from the measurement value. Residual points expressed with solid circles are applied to a subsequent process.

In the use time distinguishing step (S300), a correlation of the decided sensory temperature and the power consumption based on the sensory temperature is analyzed. As a result, the user divides a use time of using an electrical apparatus and a non-use time. In an embodiment, for example, if the method for estimating power consumption is applied to an office, the use time of using the electrical apparatus may be working hours for which the user is on duty. The non-use time may be non-working hours such as a holiday, or the like.

Further, in an embodiment, a temperate used to divide the use time may be an absolute temperature based on a thermometer, but more preferably, the sensory temperature indicating a degree sensed by the user may be used.

In detail, in an embodiment, in the use time dividing step (S300), a working date and the working hours may be analyzed as the use time through analyzing the correlation between the sensory temperature and the power consumption. The correlation may be digitized by using a Pearson correlation coefficient or Spearman correlation coefficient. In this case, since the correlation coefficient is a numerical value for finding linearity between two variables, the correlation analysis is performed individually in the cases where the sensory temperature is high or low based on a comfortable temperature (e.g., 15° C.) felt by a human body.

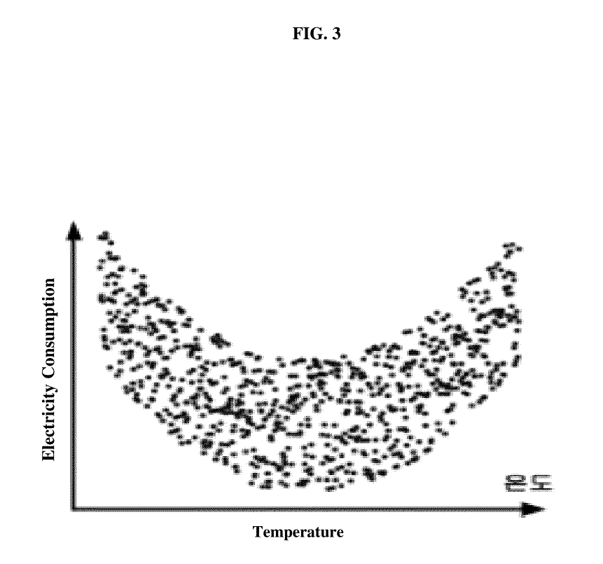

Further, the correlation analysis between a difference from the comfortable temperature and the power consumption may be performed. This is to complement that the Pearson correlation coefficient is 0 due to the temperature-power consumption relationship as illustrated in the FIG. 3.

The working date and the working hours may be classified based on time and date at which the correlation is strong. In an embodiment, August 10 is selected for the non-use time data, because its correlation between temperature and energy use is not fit with the ones of other days as shown in table 1. August 10 is reasonably assumed that no people is present in the office or household. The energy consumption function for temperature can be constructed except for August 10, which makes the function accurate than not. Further, when actual usage of energy largely deviates from the prediction by the function, it can be assumed as an abnormal situation arises and a notification is sent to the user.

TABLE 1

| | Aug 8 | Aug 9 | Aug 10 | Aug 11 | Aug 12 | Aug 13 |
|---|---|---|---|---|---|---|
| Temp | 40° C. | 39° C. | 41° C. | 38° C. | 42° C. | 39° C. |
| Energy | 1000 W | 1050 W | 150 W | 950 W | 1000 W | 1100 W |

Therefore, various analyses may be achieved through the classified date. For example, the correlation may be analyzed by a unique holiday of only a work place in addition to the weekend and the holiday. Further, the working hours may be classified by considering that the power consumption for each time before and after each time is compared to be largely different.

Table 2 given below shows a significance probability of a correlation between the power consumption and the temperature in one office. It can be seen that the significance probability (p-value) for June 4 has a comparatively large value and this coincides with a fact that off-duty caused due to a local election. That is, although advance information regarding the working date may not be known, information on the holiday may be known from the relationship between the measurement value and the temperature.

TABLE 2

| Date | Significance probability (p-value) |
|---|---|
| Jun. 02, 2014 | 9.46757969799705e−08 |
| Jun. 03, 2014 | 0.175720931318454 |
| Jun. 04, 2014 | 0.853585983742423 |
| Jun. 05, 2014 | 5.54285772835783e−08 |
| Jun. 06, 2014 | 0.237057806417057 |

When it is determined that a corresponding date is not the working date in spite of weekdays through the above method, this case is excluded from the subsequent calculation of the power consumption.

In the base consumption extracting step (S400), base consumption of an electronic apparatus is extracted by using the power consumption used for a non-use time.

In an embodiment, the base power consumption required for maintaining the office is extracted from the power consumption for a use time other than a non-working date or the working hours at the working date. In this case, the base consumption may be expressed with a center value of the total power consumption. Although only one occupant is present due to night overtime work or weekend work, the corresponding power consumption may significantly increases. As a result, when the base power consumption is extracted as an average value, there is a possibility that a significant error may occur. Therefore, in order to remedy such a disadvantage, the base consumption of the office may be defined with the center value.

Further, in the threshold temperature and power consumption continuous function extracting step (S500), a phenomenon in which the power consumption varies based on the sensory temperature is expressed with a relationship. Preferably, in the case of the sensory temperature, a temperature actually felt by a person is expressed with the numerical value by considering an atmospheric temperature and humidity.

A detailed formula is similar to an equation given below, where t represents an outdoor temperature, h represents relative humidity (the range of 0 and 1), and T represents the sensory temperature.

$$T := - 1.3 + 0.92 t + 2.2 ( 2.862 \cdot {10}^{8} - 1.0897 \cdot {10}^{5} t - 9493.4 {t}^{2} + 58.22 {t}^{3} ) exp ( \frac{- 5450}{t + 273.15} h ) \qquad [ Equation 1 ]$$

In general, the persons feel thermal dissatisfaction at a temperature higher or lower than a corresponding temperature based on the sensory temperature (e.g, 15° C.) at which the persons feel comfort to actuate a heating or cooling apparatus in the office. Further, since a temperature difference from the comfortable temperature is larger, the persons tend to more strongly actuate the heating or cooling apparatus.

However, there is a physical limit in lowering or raising an indoor temperature through the heating or cooling apparatus in spite of such a tendency. As a result, when the temperature deviates from a specific limit value, consumption of the heating or cooling apparatus may be limited regardless of the temperature. For example, in the summer season in which an abnormal high temperature occurs, although the cooling apparatus is fully actuated, there is a limit in increasing the power consumption due to a limit in a unique output of the cooling apparatus.

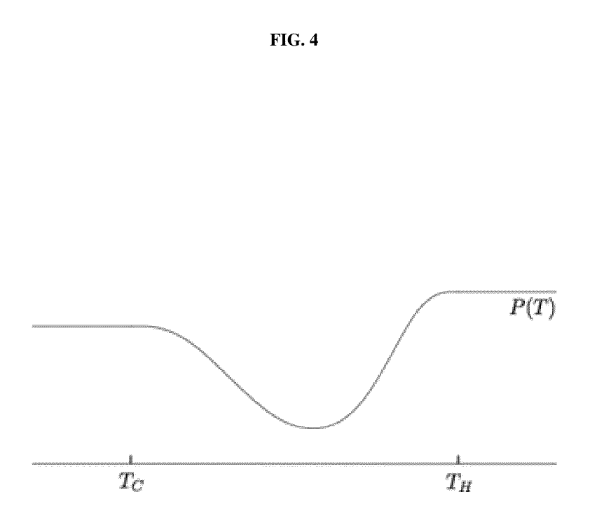

Such a phenomenon may be expressed by a function illustrated in the FIG. 4 and a function between the power consumption and the temperature is extracted through an equation given below. That is, in an embodiment, a threshold temperature includes a first threshold temperature required to maximum actuation of the heating apparatus and a second threshold temperature required to maximum actuation of the cooling apparatus. In extracting the temperature or power consumption continuous function, a continuous function for power consumption at the first threshold temperature is extracted, power consumption at the second threshold temperature is extracted, and power consumption between the first threshold temperature and the second threshold temperature is extracted.

In this case, it is assumed that the first threshold temperature is TC. The second threshold temperature is TH as the temperature to maximally use the HVAC apparatus while representing P as the power consumption and T as the sensory temperature.

$$P ( T ) = \{ \begin{matrix}{a}_{4} {T}^{4} + {a}_{3} {T}^{3} + {a}_{2} {T}^{2} + {a}_{1} {T}^{1} + {a}_{0} & if {T}_{C} \leq T \leq {T}_{H} \\ P ( {T}_{C} ) & if T < {T}_{C} \\ P ( {T}_{H} ) & if T > {T}_{H}\end{matrix} \\ {lim}_{T -> {T}_{c} +} {P}^{′} ( T ) = {lim}_{T -> {T}_{H} -} {P}^{′} ( T ) = 0 \qquad [ Equation 2 ]$$

Herein, in a range [TC, TH] between a maximum temperature limit value and a minimum temperature limit value, it is assumed that a relational express between a temperature and power consumption is represented by quaternary formula. As a result, it is expressed that when the temperature is increased or decreased based on a minimum point, the power consumption is also increased.

Further, since the operation of the HVAC apparatus is minimized at the minimum point, the temperature at this time is classified to be a comfortable temperature. In a range beyond the temperature limit value, on the assumption that the power consumption is further not increased but maintained at the maximum consumption, the temperature is expressed by a constant function. In addition, generally, a relationship between the temperature and the power consumption is expressed by a differentiable continuous function.

A condition for the limit of function P defined in the above Equation is the same as a condition for the differentiable continuous function. In order to satisfy the condition, a differential value at maximum or minimum temperature limit values needs to be 0. Accordingly, the differentiation of function P at the (TC, TH) section needs to be a tertiary formula like the following Equation.

$$\begin{matrix}{P}^{′} ( T ) = ( T - {T}_{C} ) ( T - {T}_{H} ) ( aT + b ) \\ = {aT}^{3} + \{ - a ( {T}_{C} + {T}_{H} ) + b \} {T}^{2} + \\ \{ - b ( {T}_{C} + {T}_{H} ) + {aT}_{C} {T}_{H} \} T + {bT}_{C} {T}_{H}\end{matrix} \qquad [ Equation 3 ]$$

When the function P is expressed therefrom,

$$P ( T ) = \frac{a}{4} {T}^{4} + \frac{- a ( {T}_{C} + {T}_{H} ) + b}{3} {T}^{3} + \frac{- b ( {T}_{C} + {T}_{H} ) + {aT}_{C} {T}_{H}}{2} {T}^{2} + {bT}_{C} {T}_{H} T + c \qquad [ Equation 4 ]$$

The above Equation is the same. That is, the function P may be expressed through five parameters of a, b, c, TC, and TH. The function P defined in the entire real number area may be expressed without introducing an additional parameter. In summary, the function P may be simply expressed by the following Equation,

$$P ( T ) = \{ \begin{matrix}{a}_{4} {T}^{4} + {a}_{3} {T}^{3} + {a}_{2} {T}^{2} + {a}_{1} {T}^{1} + {a}_{0} & if {T}_{C} \leq T \leq {T}_{H} \\ P ( {T}_{C} ) & if T < {T}_{C} \\ P ( {T}_{H} ) & if T > {T}_{H}\end{matrix} \\ where \\ {a}_{4} = \frac{a}{4} \\ {a}_{3} = \frac{- a ( {T}_{C} + {T}_{H} ) + b}{3} \\ {a}_{2} = \frac{- b ( {T}_{C} + {T}_{H} ) + {aT}_{C} {T}_{H}}{2} \\ {a}_{1} = {bT}_{C} {T}_{H} \\ {a}_{0} = c \qquad [ Equation 5 ]$$

In the calculating of the estimated power consumption step (S600), the estimated power consumption is calculated by excluding a base consumption and a minimum value of the continuous function from the calculated power consumption.

In an embodiment, in the calculating of the estimated power consumption step (S600), on the assumption that the consumption of the electrical apparatus other than the HVAC apparatus used in an office is constant regardless of a temperature. The power consumptions of the HVAC apparatus and non-HVAC apparatuses may be divided. That is, in the temperature, at a comfortable temperature, the HVAC apparatus is not operated but the non-HVAC apparatuses are operated.

Accordingly, at the corresponding temperature, the function extracted in the threshold temperature or power consumption constinious function step (S500) has a minimum value. At the time, the function value is referred to as an estimating amount for a non-HVAC element.

Further, a value obtained by subtracting a minimum value of the function from the function in the extracting of the temperature or power consumption function step (S500) is referred to as the estimating amount for an HVAC element.

In detail, the estimated power consumption is calculated by analyzing an power consumption generated for a working time based on the aforementioned sensory temperature. First, the sensory temperature and the power consumption for each time are set as Ti and Pi. The parameters are estimated through the solution of the following least squares problem. In this case, the differentiation of the function P for the parameters TC and TH becomes a Dirac delta function, and since it is difficult to numerically calculate the Dirac delta function, a minimizing method is applied without using the differentiation.

$${min}_{{T}_{C} , {T}_{H} , {a}_{4} , … , {a}_{0}} {\sum }_{i = 1}^{n} {( P ( {T}_{i} ) - {P}_{i} )}^{2} \\ subject to {lim }_{T -> {T}_{c} +} {P}^{′} ( T ) = {lim}_{T -> {T}_{H} -} {P}^{′} ( T ) = 0 \\ {T}_{c} \leq {T}_{H} \qquad [ Equation 6 ]$$

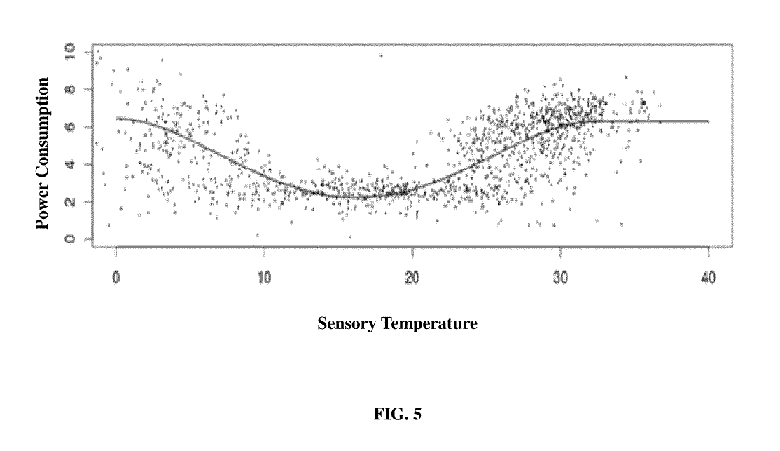

In order to reflect usage characteristics for each day of the week and each time of an electrical apparatus (preferably, a heating ventilation and air conditioning (HVAC) apparatus), the above function is estimated for each day of the week and each time with respect to when people is present at office, household, etc. When the data is insufficient, each day of the week may be divided into midweek and weekend. At the time, the power consumption based on the estimated temperature may be represented as shown in the FIG. 5.

The power consumption of the HVAC apparatus is defined as a value obtained by subtracting the base consumption and the minimum value of the estimated function from P(T−i) introducing a temperature at the corresponding time in the estimated function P. In detail, when the power consumption measured at an actual corresponding time is y, the estimated base consumption is a, the consumption of the non-HVAC apparatus defined as the minimum value of the estimated function is b, and a value obtained by introducing the temperature at the corresponding time to the estimated function and subtracting b is c, the consumption may be divided and estimated like Table 3 according to the actually measured value.

TABLE 3

| | | | HVAC | |
|---|---|---|---|---|
| | | Non-HVAC | apparatus | Other |
| | Base | apparatus | consumption | consumption |
| Measured value (y) | consumption (a) | consumption (b) | (c = P(T − i) − b) | (d) |
| 0 <= y < a | y | 0 | 0 | 0 |
| a <= y < a + b | a | y − (a + b) | 0 | 0 |
| (a + b) <= y < (a + b + c) | a | b | y − (a + b) | 0 |
| (a + b + c) <= y | a | b | c | y − (a + b + c) |

Furthermore, in an embodiment, the power consumption may be predicted by a method of estimating the power consumption. That is, the total power consumption at non-working days and overtime hours may be predicted as the base consumption, and the power consumption at other working hour zones may predict the power consumption as a value calculated by introducing the sensory temperature to the estimated function.

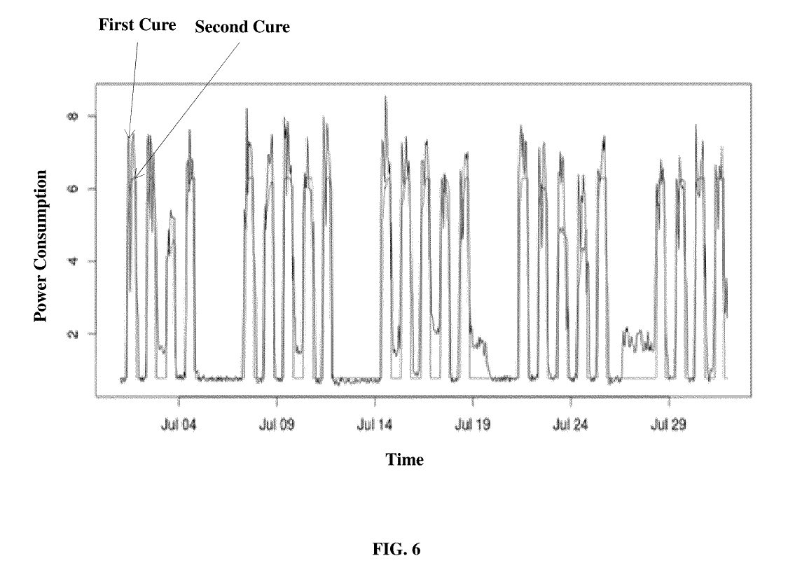

FIG. 6 is an example graph illustrating a result acquired by separating the power consumption for each element and approximating the separated power consumption based on the estimation of the power consumption in the proposed method.

The first curve is an actual measured value, and second curve is a value expressed through the prediction. It can be seen that the power consumption for the weekend is approximated well, and as a result, the base consumption is expressed well.

Further, in the weekend before July 29, it can be seen that since the power consumption is largely increased as compared with the base consumption, the worker exists. A notification for a non-general occupancy pattern may be provided through a difference between the predicted value and the actual measured value.

The various actions, acts, blocks, steps, or the like of the FIG. 1 may be performed in the order presented, in a different order or simultaneously. Further, in some embodiments, some of the actions, acts, blocks, steps, or the like may be omitted, added, modified, skipped, or the like without departing from scope of the invention.

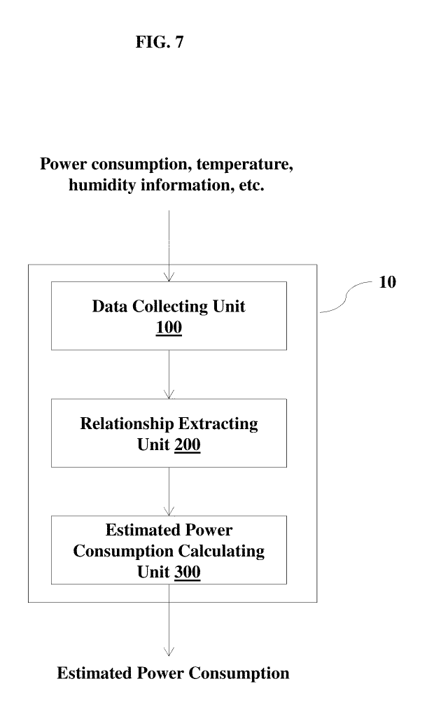

Further the method of estimating the power consumption according to the present invention may be performed by an apparatus 10 of estimating power consumption as shown in the FIG. 7. In an embodiment, the apparatus 10 includes a data collecting unit 100, a relationship extracting unit 200, and an estimated power consumption calculating unit 300.

That is, the data collecting unit 100 can be configured to collect environmental information including power consumption and temperature information. The relationship extracting unit 200 can be configured to analyze a correlation of the determined sensory temperature and the power consumption based on the sensory temperature. Further, the relationship extracting unit 200 can be configured to divide a use time, when the user uses the electrical apparatus, and a non-use time. Further, the relationship extracting unit 200 can be configured to extract the base consumption of the electrical apparatus by using the power consumption used for the non-use time. Furthermore, the relationship extracting unit 200 can be configured to extract a threshold temperature which requires a maximum operation of the electrical apparatus and extracting a continuous function between temperature (below or above the threshold temperature) and power consumption. The threshold temperature described herein requires a maximum operation of the electrical apparatus.

Further, the estimated power consumption calculating unit 300 calculates the power consumption based on a predetermined temperature from the continuous function and calculates the estimated power consumption except for the base consumption.

According to the present invention, a relationship of power consumption based on a purpose, in detail, a power consumption pattern is separated by considering whether a user is present in a building to provide consumption for respective patterns. Further, the estimated consumption and actual consumption are compared to provide user notification information regarding an abnormal situation and future power consumption prediction information can be provided through a relationship of calculated temperature or power consumption.

The FIG. 7 illustrates a limited overview of the apparatus 10 for estimating the power consumption but, it is to be understood that other embodiments are not limited thereto. The labels provided to each unit or component is only for illustrative purpose and does not limit the scope of the invention. Further, the one or more units can be combined or separated to perform the similar or substantially similar functionalities without departing from the scope of the invention. Furthermore, the apparatus 10 can include various other components interacting locally or remotely along with other hardware or software components to estimate the power consumption based on the temperature.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the technical spirit and scope of the embodiments as described herein.

What is claimed is:

1. A method for estimating power consumption based on a temperature, comprising:
dividing, by a relationship extracting unit, a use time and a non-use time based on an analysis of a correlation of a determined temperature and a power consumption based on said determined temperature;
extracting, by said relationship extracting unit, a base consumption of an electrical apparatus based on power consumption during said non-use time;
extracting, by said relationship extracting unit, a threshold temperature and a power consumption continuous function based on said threshold temperature and power consumption, wherein said threshold temperature requires a maximum operation of said electrical apparatus;
calculating, by an estimated power consumption calculating unit, said power consumption based on a predetermined temperature from said power consumption continuous function; and
calculating, by said estimated power consumption calculating unit, an estimated power consumption except for said base consumption.

2. The method of claim 1, further comprises:
excluding abnormal power consumption beyond a predetermined range with respect to an average of said power consumption,
wherein said correlation is analyzed between said power consumption except for said abnormal power consumption and said determined temperature.

3. The method of claim 1, wherein said base consumption is a center value of the power consumption during said non-use time.

4. The method of claim 1, extracting said threshold temperature and said continuous function based on said threshold temperature and power consumption comprises:
extracting said power consumption continuous function for said power consumption at a first threshold temperature, wherein said first threshold temperature requires a maximum operation of a heating apparatus
extracting said power consumption continuous function for said power consumption at a second threshold temperature, wherein said second threshold temperature requires a maximum operation of a cooling apparatus; and
extracting said power consumption between said first threshold temperature and said second threshold temperature.

5. The method of claim 1, wherein said estimated power consumption is calculated by excluding said base consumption and a minimum value of said power consumption continuous function from said calculated power consumption.

6. The method of claim 1, further comprising calculating power consumption of an non-Heating Ventilating and Air Conditioning (HVAC) apparatus except for said base consumption and said estimated power consumption in said calculated power consumption.

7. An apparatus for estimating power consumption based on a temperature, the apparatus comprising:
a data collecting unit configured to collect environmental information including power consumption and temperature information;
a relationship extracting unit configured to:
analyze a correlation of a determined sensory temperature and said power consumption based on said sensory temperature;
divide a use time and a non-use time based on said analysis of said correlation;
extract a base consumption of an electrical apparatus based on power consumption during said non-use time; and
extract a threshold temperature and a power consumption continuous function based on said threshold temperature and power consumption, wherein said threshold temperature requires a maximum operation of said electrical apparatus; and
an estimated power consumption calculating unit configured to:
calculate said power consumption based on a predetermined temperature from said power consumption continuous function; and
calculate said estimated power consumption except for said base consumption.

8. A method for estimating power consumption based on a temperature, comprising:
dividing, by a relationship extracting unit, a use time and a non-use time based on an analysis of a correlation of a determined temperature and a power consumption based on said determined temperature;
extracting, by said relationship extracting unit, a base consumption of an electrical apparatus based on power consumption during said non-use time; and
extracting, by said relationship extracting unit, a threshold temperature and a power consumption continuous function based on said threshold temperature and power consumption, wherein said threshold temperature requires a maximum operation of said electrical apparatus.
